(19) United States
(12) Patent Application Publication
(10) Pub. No.: US 2024/0000287 A1
(43) Pub. Date: Jan. 4, 2024

(54) WIRELESS POWER ENABLING UNDERCOUNTER KITCHEN APPLIANCE

(71) Applicant: Midea Group Co., Ltd., Shunde (CN)

(72) Inventors: Bassam Fawaz, Louisville, KY (US); John Kenneth Hooker, Louisville, KY (US)

(21) Appl. No.: 17/854,787

(22) Filed: Jun. 30, 2022

(51) Int. Cl. A47L 15/00; A47L 15/42; H05B 6/12; H05B 6/06

(52) U.S. Cl. CPC A47L 15/0097; A47L 15/42; H05B 6/1236; H05B 6/1218; H05B 6/06; H05B 2213/06

(57) ABSTRACT

An undercounter kitchen appliance, for example a dishwasher, includes an enclosure with a top surface that is located near a lower surface of a countertop when the undercounter kitchen appliance is installed, and a wireless power transmitter located near the top surface of the undercounter kitchen appliance, where the power transmitter supplies power to a small kitchen appliance disposed on an upper surface of the countertop.

### BACKGROUND

Various kitchen appliances may be used in many single-family and multi-family residential applications. Many of these products may be disposed under a kitchen counter, for example dishwashers, wine coolers, refrigerator drawers, laundry washing machines and/or dryers, and the like. These undercounter installations allow for the electrical power connections to these devices to be neatly hidden away, and allow for maximizing available counter space.

However, various small kitchen appliances, such as blenders, toasters, etc. conventionally utilize a power cord that must be plugged into an outlet (e.g., a wall outlet, an outlet location in a kitchen island, or the like) in order to use the appliance. Furthermore, these cords for the small kitchen appliances must be stored when they are not in use. As such, the power cords for small appliances are often cumbersome and unsightly.

### SUMMARY

The herein-described embodiments address these and other problems associated with the art by providing a undercounter kitchen appliance with a wireless power transmitter for powering a small kitchen appliance. In some aspects, an undercounter kitchen appliance includes an enclosure with a top surface that is disposed proximate a lower surface of a countertop when installed, and a wireless power transmitter disposed proximate the top surface of the enclosure, the wireless power transmitter supplying power to a small kitchen appliance located on an upper surface of the countertop.

In some implementations, the undercounter kitchen appliance is a dishwasher. In some implementations, the undercounter kitchen appliance additionally includes a controller within the enclosure to control operation of the undercounter kitchen appliance; and a user interface coupled to the controller, where the user interface is used to by the controller to receive user input to control the undercounter kitchen appliance and the small kitchen appliance.

In some implementations, the undercounter kitchen appliance additionally includes a fan used by the undercounter kitchen appliance in connection with performing a cycle using the undercounter kitchen appliance. In some such implementations, the fan is further configured to cool the wireless power transmitter. In other implementations, the fan is a first fan and the undercounter kitchen appliance further comprises a second fan configured to cool the wireless power transmitter.

In some implementations, the undercounter kitchen appliance additionally includes an indicator positioned on the upper surface of the countertop to indicate proper placement of the small kitchen appliance to receive power from the wireless power transmitter. In some such implementations, the indicator is positioned on the countertop using a first magnet configured to magnetically pair with a second magnet \under the countertop and proximate the wireless power transmitter. In other implementations, the undercounter kitchen appliance further includes an audio or visual indicator to indicate proper placement of the small kitchen appliance to receive power from the wireless power transmitter. In some such implementations, the audio or visual indicator is an audio indicator that is a series of beeps that increases in frequency or pitch as the small kitchen appliance nears the proper placement of the small kitchen appliance. In other such implementations, the audio or visual indicator is a visual indicator that is one or more blinking lights that blink faster or become solid as the small kitchen appliance nears the proper placement of the small kitchen appliance.

In some implementations, undercounter kitchen appliance additionally includes a controller coupled to the undercounter kitchen appliance to detect power usage of the undercounter kitchen appliance or small kitchen appliance. In some instances, the controller determines the power usage of the undercounter kitchen appliance and provides, based on the determination of power usage, reduced power capacity to the small kitchen appliance. In other implementations, the controller determines the power usage of the small kitchen appliance, and provide, based on the determination of power usage, reduced power capacity to the undercounter kitchen appliance.

In some implementations, the wireless power transmitter is an induction coil and the small kitchen appliance is a cooking apparatus, and the induction coil generates heat in the cooking apparatus.

In some implementations, the undercounter kitchen appliance additionally includes a riser apparatus to raise the wireless power transmitter closer to the lower surface of the countertop. In some such implementations, the riser apparatus includes a compression spring that in a first position holds the wireless power transmitter proximate the undercounter kitchen appliance and in a second position raises the wireless power transmitter towards the lower surface of the countertop. In other such implementations, the riser apparatus includes a lift mechanism that is actuatable during installation of the undercounter kitchen appliance to raise the wireless power transmitter towards the lower surface of the countertop.

In another aspect, a system for powering a small kitchen appliance including a wireless power transmitter to be located near an undercounter kitchen appliance when installed, where the wireless power transmitter draws power from the undercounter kitchen appliance and supplies power to the small kitchen appliance located on an upper surface of a countertop; and a controller coupled to the undercounter kitchen appliance to detect power usage of the undercounter kitchen appliance or small kitchen appliance and regulate power to the other of undercounter kitchen appliance or small kitchen appliance.

In some implementations, the controller is further configured to determine the power usage of the undercounter kitchen appliance, and provide, based on the determination of the power usage of the undercounter kitchen appliance, reduced power capacity to the small kitchen appliance. In other implementations, the controller is further configured to: determine the power usage of the small kitchen appliance, and provide, based on the determination of the power usage of the small kitchen appliance, reduced power capacity to the undercounter kitchen appliance.

In some implementations, the system for powering a small kitchen appliance additionally includes an indicator on the upper surface of the countertop to indicate proper placement of the small kitchen appliance to receive power from the wireless power transmitter. In other instances, the indicator is located on the undercounter kitchen appliance to indicate proper placement of the small kitchen appliance to receive power from the wireless power transmitter.

In some implementations, the system for powering a small kitchen appliance additionally includes a riser apparatus coupled to an enclosure of the undercounter kitchen appliance and configured to raise the wireless power transmitter closer to a lower surface of the countertop. In other implementations, the wireless power transmitter is an induction coil and the small kitchen appliance is a cooking apparatus, and wherein the induction coil is configured to generate heat in the cooking apparatus. In still other implementations, the system for powering a small kitchen appliance additionally includes a fan configured to cool the wireless power transmitter.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a perspective view of an exemplary undercounter kitchen appliance, a dishwasher, consistent with some embodiments of the invention.

FIG. 2 is a block diagram of an example control system for the dishwasher of FIG. 1.

FIGS. 3A-B are front views of an exemplary undercounter kitchen appliance, a dishwasher, with a wireless power transmitter to power a small kitchen appliance, consistent with some embodiments of the invention. FIG. 3A illustrates the wireless power transmitter in a first position; FIG. 3B illustrates the wireless power transmitter in a second position.

FIGS. 4A-B are partial front views of an exemplary undercounter kitchen appliance, a dishwasher, with a wireless power transmitter to power a small kitchen appliance, consistent with some embodiments of the invention. FIG. 4A illustrates the wireless power transmitter in a first position; FIG. 4B illustrates the wireless power transmitter in a second position.

FIG. 5 is a partial exploded view of an exemplary undercounter kitchen appliance with a wireless power transmitter to power a small kitchen appliance, consistent with some embodiments of the invention.

FIGS. 6A-B are front views of an exemplary undercounter kitchen appliance with a wireless power transmitter to power a small kitchen appliance, consistent with some embodiments of the invention. FIG. 6A illustrates a power sharing scheme where the undercounter kitchen appliance is the priority; FIG. 6B illustrates a power sharing scheme where the small kitchen appliance is the priority.

### DETAILED DESCRIPTION

In some embodiments consistent with the invention, an undercounter kitchen appliance, such as a dishwasher, wine cooler, refrigerator or freezer drawer, or the like, may include a wireless power transmitter that is located near the top surface of the undercounter kitchen appliance such that when the undercounter kitchen appliance is installed the wireless power transmitter is located near and/or contacting a lower surface of the countertop, thereby enabling the wireless power transmitter to wirelessly supply power through the countertop to a small kitchen appliance disposed on an upper surface of the countertop.

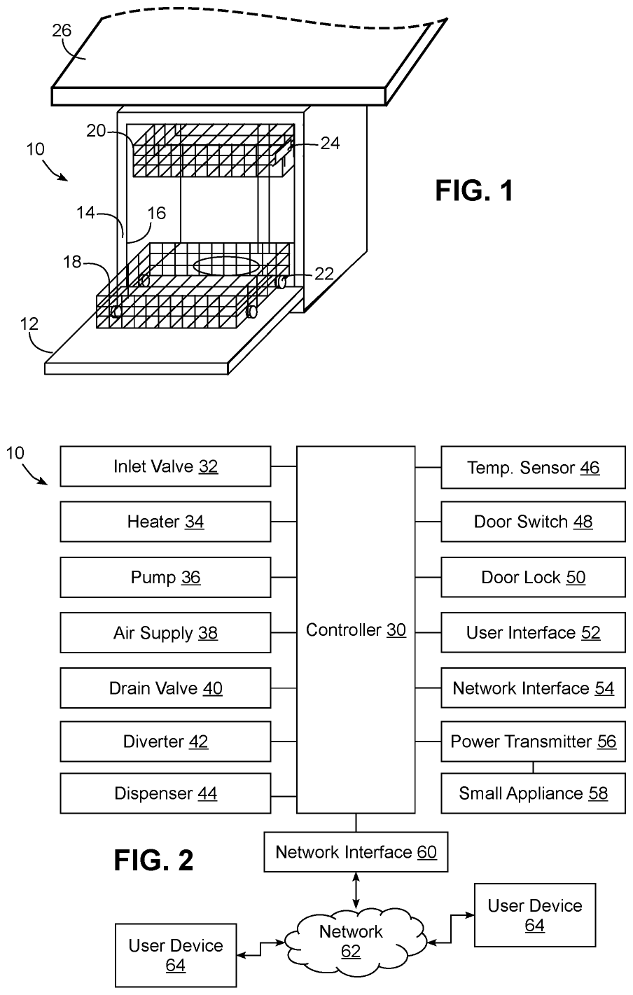

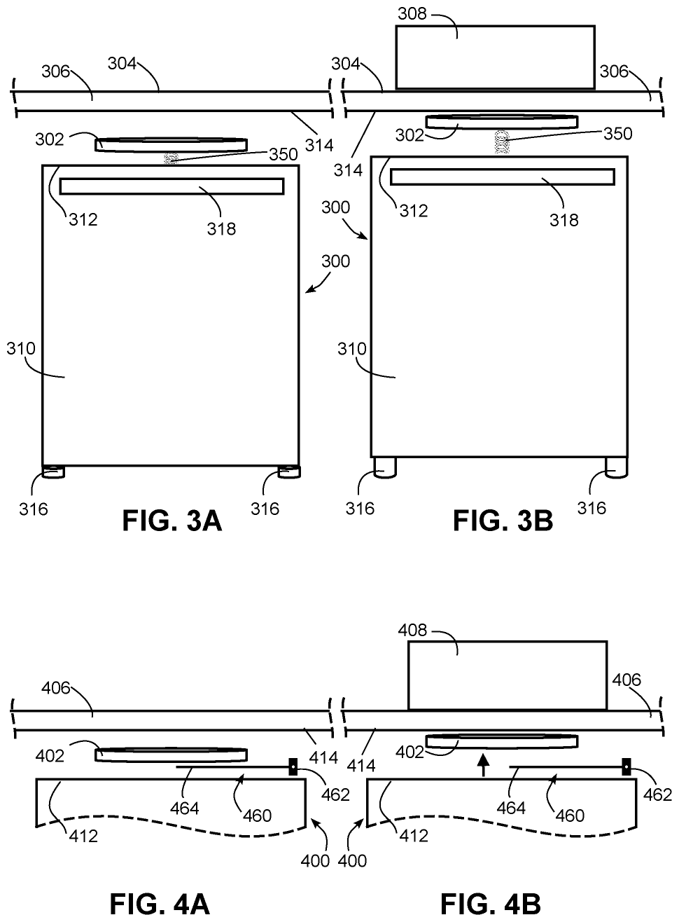

Turning now to the drawings, wherein like numbers denote like parts throughout the several views, FIG. 1 illustrates an example undercounter kitchen appliance, a dishwasher 10, in which the various technologies and techniques described herein may be implemented. Dishwasher 10 is a residential-type built-in dishwasher, and as such includes a front-mounted door 12 that provides access to a wash tub 16 housed within the cabinet or housing 14. Door 12 is generally hinged along a bottom edge and is pivotable between the opened position illustrated in FIG. 1 and a closed position (not shown). When door 12 is in the opened position, access is provided to one or more sliding racks, e.g., lower rack 18 and upper rack 20, within which various utensils are placed for washing. Lower rack 18 may be supported on rollers 22, while upper rack 20 may be supported on side rails 24, and each rack is movable between loading (extended) and washing (retracted) positions along a substantially horizontal direction. Control over dishwasher 10 by a user is generally managed through a control panel or user interface (see 318 in FIGS. 3A-B) typically disposed on a top or front of door 12, and it will be appreciated that in different dishwasher designs, the control panel may include various types of input and/or output devices, including various knobs, buttons, lights, switches, textual and/or graphical displays, touch screens, etc. through which a user may configure one or more settings and start and stop a wash cycle.

The embodiments discussed hereinafter will focus on the implementation of the hereinafter-described techniques within dishwasher, specifically a hinged-door dishwasher. However, it will be appreciated that the herein-described techniques may also be used in connection with other types of dishwashers in some embodiments. For example, the herein-described techniques may be used in commercial applications in some embodiments. Moreover, at least some of the herein-described techniques may be used in connection with other dishwasher configurations, including dishwashers utilizing sliding drawers. Additionally, while a dishwasher is being utilized as an exemplary undercounter appliance herein, this is not intended to be limiting. In some implementations, the undercounter kitchen appliance may be a wine cooler, a refrigerator or freezer drawer, a laundry washing machine and/or dryer, or any other powered undercounter appliance.

Now turning to FIG. 2, dishwasher 10 (or other undercounter appliance) may be under the control of a controller 30 that receives inputs from a number of components and drives a number of components in response thereto. Controller 30 may, for example, include one or more processors and a memory (not shown) within which may be stored program code for execution by the one or more processors. The memory may be embedded in controller 30, but may also be considered to include volatile and/or non-volatile memories, cache memories, flash memories, programmable read-only memories, read-only memories, etc., as well as memory storage physically located elsewhere from controller 30, e.g., in a mass storage device or on a remote computer interfaced with controller 30.

As shown in FIG. 2, controller 30 may be interfaced with various conventional components of the dishwasher, including an inlet valve 32 that is coupled to a water source to introduce water into wash tub 16, which when combined with detergent, rinse agent and/or other additives, forms various wash fluids. Controller may also be coupled to a heater 34 that heats fluids, a pump 36 that recirculates wash fluid within the wash tub by pumping fluid to the wash arms and other spray devices in the dishwasher, an air supply 38 that provides a source of pressurized air for use in drying utensils in the dishwasher, a drain valve 40 that is coupled to a drain to direct fluids out of the dishwasher, and a diverter 42 that controls the routing of pumped fluid to different spray elements during a wash cycle. Controller 30 may also be coupled to a dispenser 44 to trigger the dispensing of detergent and/or rinse agent into the wash tub at appropriate points during a wash cycle. Additional sensors and actuators may also be used in some embodiments, including a temperature sensor 46 to determine a wash fluid temperature, a door switch 48 to determine when door 12 is latched, and a door lock 50 to prevent the door from being opened during a wash cycle. Moreover, controller 30 may be coupled to a user interface 52 including various input/output devices such as knobs, dials, sliders, switches, buttons, lights, textual and/or graphics displays, touch screen displays, speakers, image capture devices, microphones, etc. for receiving input from and communicating with a user. In some embodiments, controller 30 may also be coupled to one or more network interfaces 54, e.g., for interfacing with external devices via wired and/or wireless networks such as Ethernet, Bluetooth, NFC, cellular and other suitable networks. The controller 30 may also be interfaced with a wireless power transmitter 56, and the power transmitter may be interfaced with the small kitchen appliance 58. The power transmitter 56 (or a separate component) may be used to communicate information between the small kitchen appliance 58 and controller 30 to enable the controller 30 to control the small kitchen appliance 58 in some instances. Additionally, the power transmitter 56 may be used receive commands from the small kitchen appliance 58 in some instances. A wireless handshake may also be used, in some instances, to identify certain types of small kitchen 58 (e.g., and inductive cooktop or cooking appliance). Additional components may also be interfaced with controller 30, as will be appreciated by those of ordinary skill having the benefit of the instant disclosure.

In some embodiments, controller 30 may also be coupled to one or more network interfaces 60, e.g., for interfacing with external devices via wired and/or wireless networks such as Ethernet, Wi-Fi, Bluetooth, NFC, cellular and other suitable networks, collectively represented in FIG. 2 at 62. Network 62 may incorporate in some embodiments a home automation network, and various communication protocols may be supported, including various types of home automation communication protocols. In other embodiments, other wireless protocols, e.g., Wi-Fi or Bluetooth, may be used. In some embodiments, dishwasher 10 may be interfaced with one or more user devices 64 over network 62, e.g., computers, tablets, smart phones, wearable devices, etc., and through which the dishwasher 10 and/or small kitchen appliance 58 may be controlled. For example, network interface 60 may include a network interface card (NIC) configured to communicate according to the Ethernet protocol. Additionally, network interfaces 60 may implement a TCP/IP stack for communication according to the TCP/IP protocols. Various alternative or additional hardware or configurations for network interface 60 will be apparent to one of ordinary skill in the art.

Numerous variations and modifications to the undercounter kitchen appliance, for example the dishwasher illustrated in FIGS. 1-2 will be apparent to one of ordinary skill in the art, as will become apparent from the description below. Therefore, the invention is not limited to the specific implementations discussed herein.

Now turning to FIGS. 3A-B, in some embodiments, an undercounter kitchen appliance, such as a dishwasher 300, may include a wireless power transmitter 302 disposed below a countertop 306 to transmitter power through the countertop 306 to a small kitchen appliance 308 positioned on an upper surface 304 of the countertop. In undercounter kitchen appliance, which in this implementation is a dishwasher 300, may include an enclosure 310 for the wash tub and/or various electrical components. The enclosure 310 may additionally include a top surface 312, which in some implementations is substantially flat. In some instances, insulation may also be wrapped around the top surface. When the dishwasher 300 is installed under the countertop 306, as illustrated, the top surface 312 of the enclosure 310 may be disposed proximate the lower surface 314 of the countertop 306. In some implementations, the dishwasher 300 may additionally include feet 316, which may be raised (see e.g., FIG. 3B) in order to place top surface 312 of the enclosure 310 closer to the countertop 306.

It is generally desirable to position wireless power transmitter 302 proximate to the countertop, and in some instances, in contact with the countertop, in order to minimize the distance between the wireless power transmitter and the small kitchen appliance being powered thereby. to be able to supply power through the countertop 306 to the small kitchen appliance that is placed on an upper surface 304 of the countertop 306. Accordingly, in some implementations, in addition to, or as an alternative to raising the feet 316 of the dishwasher, a riser apparatus 350, as illustrated in FIGS. 3A and 3B, may be used. The riser apparatus may raise the wireless power transmitter 302 closer to the lower surface 314 of the countertop 306. The riser apparatus 350 may include any number of apparatuses capable of raising the wireless power transmitter 302. For example, in some implementations the riser apparatus 350 may be a spring. In some such instances, the spring may be a helical or compression spring that in a first position holds the wireless power transmitter 302 proximate the undercounter kitchen appliance (in this instance a dishwasher 300) as illustrated in FIG. 3A, and in a second position raises the wireless power transmitter 302 towards, and in some instances, presses against, the lower surface 314 of the countertop 306 as illustrated in FIG. 3B. The release of the compression spring, which moves the wireless power transmitter towards countertop 306, may be actuated by a user or installer once the dishwasher 300 installation is otherwise complete, e.g., using a mechanical catch or lever, a temporary tie down, or any other suitable temporary holding mechanism as will be appreciated by those of ordinary skill having the benefit of the instant disclosure.

In other implementations, such as illustrated in FIGS. 4A and 4B, the riser apparatus of the undercounter kitchen appliance, in this instance dishwasher 400, may include a lift mechanism 460 to raise the wireless power transmitter 402 towards the lower surface 414 of the countertop 406. The lift mechanism 460 in some embodiments may include an arm 462 attached to a rotating shaft 464, which when combined with a connecting rod, scissors mechanism, telescoping mechanism or other suitable mechanism capable of altering the elevation of the wireless power transmitter in response to a mechanical input (not illustrated), may be used to convert the circular motion into the vertical motion necessary to raise the wireless power transmitter 402 from a first position closest to the undercounter appliance (see FIG. 4A) to a second position, where the wireless power transmitter 402 is raised towards and/or contacts the lower surface of the countertop 414 (illustrated in FIG. 4B). In some instances, the lift mechanism 460 may be manually operated by a user or installer, where an individual uses their hand to actuate a crank arm of the lift mechanism 460 until the wireless power transmitter 402 is at the desired height. In other instances, a screwdriver, Allen wrench, socket and ratchet, power drill, etc. may be used to actuate the lift mechanism 460 in order to provide the necessary mechanical input to raise the wireless power transmitter 402 to the desired height.

The riser apparatuses illustrated in FIGS. 3A-B and 4A-B are not limiting, as a person of skill in the art would recognize there are many types of apparatuses that may be used to raise the wireless power transmitter 302, 402 closer to the countertop 306, 406. Other non-limiting examples of such apparatuses may include a miniature scissor lift apparatus or a telescoping lift apparatus. Furthermore, in some implementations, a motor may be paired with any of the above-mentioned apparatuses and/or paired with a system of pulleys to allow for powered actuation of the riser apparatus. In some implementations, the riser apparatus may raise the wireless power transmitter 302, 402 such that it is in contact with the lower surface 314, 414 of the countertop 306, 406.

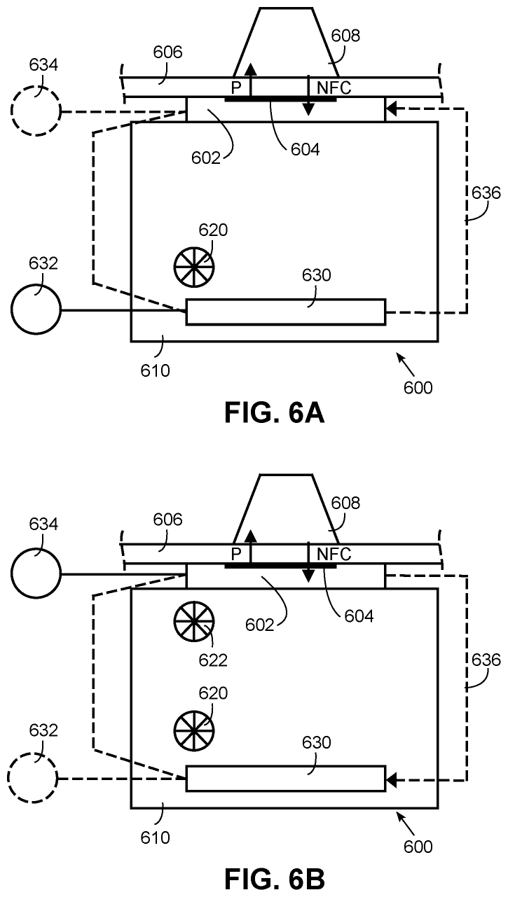

Returning now to FIGS. 3B, a small kitchen appliance 308 is illustrated as being disposed on the upper surface 304 of the countertop 306. The small kitchen appliance 308 may be any number of small appliances configured to receive wireless power. Some non-limiting examples of small kitchen appliances 308 may include a kettle, blender, rice cooker, pressure cooker, slow cooker, coffee pot, toaster, air fryer, traditional toaster, toaster oven, electric food chopper, waffle maker, juicer, can opener, food processor, bread maker, inductive cooktop or the like. As will be described in detail with respect to FIGS. 6A-B, power is wirelessly shared from the undercounter kitchen appliance (e.g., dishwasher 300) via the wireless power transmitter 302 in order to power the small kitchen appliance 308.

The undercounter kitchen appliance, dishwasher 300 in the illustrated embodiment, may include a user interface 318 that may include various input/output devices. In some implementations, the user interface 318 may include buttons, lights, textual and/or graphics displays, touch screen displays, etc. for receiving input from and communicating with a user for controlling the function of the undercounter appliance. In some implementations, the dishwasher 300 and the small kitchen appliance 308 may each include their own, discrete, user interfaces. However, in other implementations, the dishwasher 300 and small kitchen appliance 308 may share a user interface 318, for example located on the front of the dishwasher 300. In such an instance, a receiver contained within the small kitchen appliance 308 may communicate with the wireless power transmitter 302 through near field communication in order to receive control information based on user input from the shared user interface 318.

In some implementations, it may be desirable to provide an indicator to the user that the small kitchen appliance 308 is properly placed on the countertop 306 in order to receive power via the wireless power transmitter 302. In some implementations, this may be achieved by audio and/or visual cues to a user. In one example, an audio indicator may be a series of beeps or other audio indication that increases in frequency and/or pitch as the small kitchen appliance 308 nears the desired positioning for optimal power transmission/receipt. Similarly, in another example, a visual indicator may be a serious of blinking lights that may blink faster and/or become solid when the as the small kitchen appliance 308 nears the desired positioning for optimal power transmission/receipt. In some instances, there may be multiple indicators, for example audio and visual indicators utilized in conjunction with each other that the small kitchen appliance 308 is properly positioned. In some implementations, the indicator may be located on the upper surface 304 of the countertop 306; while in other implementations, the indicator may be located on the undercounter kitchen appliance (e.g., dishwasher 300) and/or the small kitchen appliance 308.

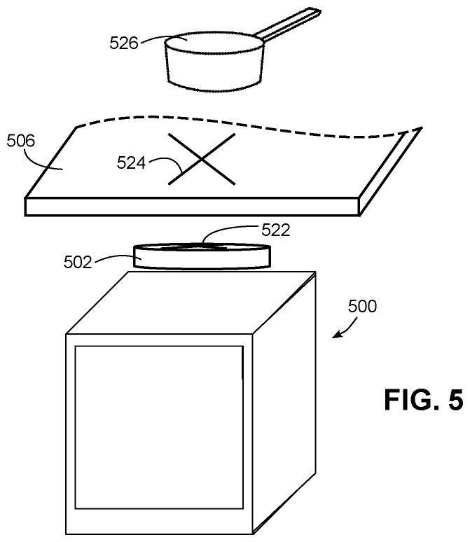

Another exemplary indicator for positioning is illustrated in FIG. 5. FIG. 5 illustrates a undercounter kitchen appliance 500, such as a dishwasher, refrigerator, or the like, which includes a wireless power transmitter 502 disposed below a countertop 506 to transmit power through the countertop to a small kitchen appliance 526. The indicator includes a first magnet 522 that is disposed on or is proximate to the wireless power transmitter 502 and a second magnet 524 that can pair with the first magnet. In some implementations, such as illustrated in FIG. 5, the second magnet 524 may be located on the countertop 506 and used as a visual indicator to the user of where the small kitchen appliance 526 is to be placed. In other implementations, the second magnet 524 may be a locator so that another indicator, such as a sticker, may be placed on the counter 506 at the proper position. In still other implementations, the second magnet 524 may be located on a lower surface of the small kitchen appliance 526; the second magnet 524 may also, in some implementations, be combined with one or more other indicator (e.g., audio or visual indicators described previously). Regardless of the location of the second magnet 524, the pairing of the first and second magnets 522, 524 may facilitate a user in knowing that the small kitchen appliance 526 is properly positioned to receive power.

In some instances, the power transmitter may be an induction coil that can heat a cooking apparatus 526 through inductive cooking. In such instances, the cooking apparatus 526, which may be a pot, pan, skillet, or the like, may have a ferromagnetic base. The ferromagnetic base of the cooking apparatus 526 may be placed on the countertop 506 above the wireless power transmitter 502 with an inductive coil (for example, a coil of copper wire with an alternating electric current passing through it). This results in an oscillating magnetic field that may wirelessly induce an electrical current in the cooking apparatus 526 resulting in heating the cooking apparatus 526. While it may be desirable in some instances to utilize the wireless power transmitter 502 and a cooking apparatus 526 for inductive cooking on a countertop 506, there is also risk of damage to the countertop 506, especially where the countertop 506 is not a heat-safe material. Accordingly, in some instances, the wireless power transmitter 502 may by default disable the induction cooking to protect the countertop 506 from inadvertent damage, e.g., by requiring a handshake signal to be communicated between the wireless power transmitter and the countertop kitchen appliance in order to power the countertop appliance. A user may be able to turn on inductive cooking when desired in some embodiments. In other embodiments, it may be desirable to preclude the use of the wireless power transmitter to directly heat ferromagnetic cooking utensils (e.g., by requiring the aforementioned handshake signal) due to the potential for damage to the countertop.

Now turning to FIGS. 6A-B, example power sharing schemes between the undercounter kitchen appliance, in this instance a dishwasher 600, and a small kitchen appliance 608 are illustrated. FIGS. 6A-B, similar to previously described embodiments, illustrate a wireless power transmitter 602 with a power coil 604 disposed below a countertop 606 to transmitter power P through the countertop to a small kitchen appliance 608. The dishwasher 600 additionally includes an enclosure 610 for the wash tub and various electrical components. Further illustrated in FIGS. 6A-B is a ventilation fan 620, for example located near the bottom of the dishwasher 600. This ventilation fan 620 may be used to dry the dishes contained within the dishwasher 600. In some implementations, such as illustrated in FIG. 6A, the ventilation fan 620 may also be used to cool to the wireless power transmitter 602, for example by altering the route of the flow of air. In other implementations, such as illustrated in FIG. 6B, there may be a second fan 622 to cool the wireless power transmitter 602. This second fan 622 may, in some implementations, be located at the top of the enclosure 610 proximate the wireless power transmitter 602. The dishwasher 600 may also include a controller 630 (see also controller 30 of FIG. 2).

Referring first to FIG. 6A, a power sharing scheme is illustrated where the undercounter kitchen appliance 600 has the priority for power usage. As illustrated in FIG. 6A, the undercounter kitchen appliance 600 may be plugged in to an outlet 632. Additionally, or alternatively, the wireless power transmitter 602 may be plugged into a second outlet 634 on the same circuit. In the example of a dishwasher, the dishwasher may be on its own circuit (typically a 15A circuit); alternatively, the dishwasher may share a circuit with a garbage disposal (typically a 20A circuit). Regardless of whether the undercounter kitchen appliance 600 has its own circuit or shares a circuit, the “excess capacity” of the circuit would be available to the wireless power transmitter 602. In some instances, the undercounter kitchen appliance 600 may have period of high power consumption that may require throttling down or reducing the amount of power transmitted to the small kitchen appliance 608. For example, where the undercounter kitchen appliance is a dishwasher 600, the power usage or loads on the circuit may include the heater, recirculating pump, drain pump, dispensing valves, fan, etc. When the dishwasher is running, the power consumed by the dishwasher may necessitate throttling down or reducing the wireless power transmitter 602 to prevent overloading of the circuit. In some instances, a dishwasher 600 may be able to measure its power usage or load via a current transformer. Alternatively, the dishwasher 600 may be able to estimate its power usage load based on which loads are currently on and how much power each of the loads consume. Accordingly, the controller 630 of the undercounter kitchen appliance, in this instance a dishwasher 600, may send the excess power or circuit capacity to the wireless power transmitter 602, for example by a serial communication link 636 to avoid circuit overload.

Power P may then flow from the wireless power transmitter 602 to the receiver of the small kitchen appliance 608. In some implementations, the receiver may communicate with the wireless power transmitter 602, for example through one or more wireless communication protocols, such as near field communication NFC. Using, for example NFC, the receiver of the small kitchen appliance 608 may be able to ask the wireless power transmitter 602 to ask the controller 630 for more (or less) power to meet the needs of the small kitchen appliance 608. In order to prevent overloading the circuit, the wireless power transmitter 602, via the controller 630, may limit the maximum power available according to determined “excess circuit capacity” described previously.

Referring next to FIG. 6B, a power sharing scheme is illustrated where the small kitchen appliance 608 has the priority for power usage. In some implementations, the wireless power transmitter may be plugged directly into an outlet 634. Additionally, or alternatively, the dishwasher may be plugged into another outlet 632 on the same circuit. In this implementation, the wireless power transmitter 602, which has power usage priority, may throttle down or reduce the amount of power provided to the dishwasher 600 in order to prevent the circuit from overloading.

In some implementations, even where the small kitchen appliance 608 has priority for power usage, the dishwasher controller 630 may be where the logic remains. In such instances, the wireless power transmitter 602 may be a way of communicating between the dishwasher 600 and the small kitchen appliance 608, but the control of the power sharing may remain with the dishwasher controller 630.

The wireless power transmitter 602 may be able to measure its power usage or load via a current transformer, shunt, Hall Effect device, or other current measuring techniques. Alternatively, the wireless power transmitter 602 may be able to estimate its power usage based on communication with the wireless power transmitter 602, for example through one or more wireless communication protocols, such as near field communication NFC. For example, the small kitchen appliance 608 may communicate to the wireless power transmitter 602 via NFC the type of small kitchen appliance 608 being utilized and how much power they typically consume. Accordingly, the wireless power transmitter 602 may send the excess power or circuit capacity to the undercounter kitchen appliance (dishwasher 600), for example by a serial communication link 636 to avoid circuit overload.

Although the various embodiments described herein have utilized a dishwasher as an exemplary undercounter kitchen appliance, this is not to be understood as limiting. The undercounter kitchen appliance may be a wine cooler, a refrigerator or freezer drawer, or any other powered undercounter appliance.

Other modifications may be made to the illustrated embodiments without departing from the spirit and scope of the invention. Therefore, the invention lies in the claims hereinafter appended.

What is claimed is:

1. An undercounter kitchen appliance, comprising:
an enclosure including a top surface configured to be disposed proximate a lower surface of a countertop when the undercounter kitchen appliance is installed; and
a wireless power transmitter disposed proximate the top surface of the enclosure, the wireless power transmitter configured to supply power to a small kitchen appliance disposed on an upper surface of the countertop.

2. The undercounter kitchen appliance of claim 1, wherein the undercounter kitchen appliance is a dishwasher.

3. The undercounter kitchen appliance of claim 1 further comprising:
a controller disposed in the enclosure and configured to control operation of the undercounter kitchen appliance; and
a user interface coupled to the controller, wherein the user interface is used to by the controller to receive user input to control the undercounter kitchen appliance and the small kitchen appliance.

4. The undercounter kitchen appliance of claim 1 further comprising a fan used by the undercounter kitchen appliance in connection with performing a cycle using the undercounter kitchen appliance.

5. The undercounter kitchen appliance of claim 4, wherein the fan is further configured to cool the wireless power transmitter.

6. The undercounter kitchen appliance of claim 4, wherein the fan is a first fan and the undercounter kitchen appliance further comprises a second fan configured to cool the wireless power transmitter.

7. The undercounter kitchen appliance of claim 1 further comprising an indicator positioned on the upper surface of the countertop and configured to indicate proper placement of the small kitchen appliance to receive power from the wireless power transmitter.

8. The undercounter kitchen appliance of claim 7, wherein the indicator is positioned on the countertop using a first magnet configured to magnetically pair with a second magnet disposed under the countertop and proximate the wireless power transmitter.

9. The undercounter kitchen appliance of claim 1 further comprising an audio or visual indicator configured to indicate proper placement of the small kitchen appliance to receive power from the wireless power transmitter.

10. The undercounter kitchen appliance of claim 9, wherein the audio or visual indicator is an audio indicator that is a series of beeps that increases in frequency or pitch as the small kitchen appliance nears the proper placement of the small kitchen appliance.

11. The undercounter kitchen appliance of claim 9, wherein the audio or visual indicator is a visual indicator that is one or more blinking lights that blink faster or become solid as the small kitchen appliance nears the proper placement of the small kitchen appliance.

12. The undercounter kitchen appliance of claim 1 further comprising a controller coupled to the undercounter kitchen appliance and configured to detect power usage of the undercounter kitchen appliance or small kitchen appliance.

13. The undercounter kitchen appliance of claim 12, wherein the controller is further configured to:
determine the power usage of the undercounter kitchen appliance; and
provide, based on the determination of power usage, reduced power capacity to the small kitchen appliance.

14. The undercounter kitchen appliance of claim 12, wherein the controller is further configured to:
determine the power usage of the small kitchen appliance; and
provide, based on the determination of power usage, reduced power capacity to the undercounter kitchen appliance.

15. The undercounter kitchen appliance of claim 1, wherein the wireless power transmitter is an induction coil and the small kitchen appliance is a cooking apparatus, and wherein the induction coil is configured to generate heat in the cooking apparatus.

16. The undercounter kitchen appliance of claim 1 further comprising a riser apparatus to raise the wireless power transmitter closer to the lower surface of the countertop.

17. The undercounter kitchen appliance of claim 16 wherein the riser apparatus includes a compression spring that in a first position holds the wireless power transmitter proximate the undercounter kitchen appliance and in a second position raises the wireless power transmitter towards the lower surface of the countertop.

18. The undercounter kitchen appliance of claim 16 wherein the riser apparatus includes a lift mechanism that is actuatable during installation of the undercounter kitchen appliance to raise the wireless power transmitter towards the lower surface of the countertop.

19. A system for powering a small kitchen appliance, the system comprising:
a wireless power transmitter configured to be disposed proximate an undercounter kitchen appliance when the undercounter kitchen appliance is installed;
wherein the wireless power transmitter configured to draw power from the undercounter kitchen appliance and supply power to the small kitchen appliance disposed on an upper surface of a countertop; and
a controller coupled to the undercounter kitchen appliance and configured to detect power usage of the undercounter kitchen appliance or small kitchen appliance and regulate power to the other of undercounter kitchen appliance or small kitchen appliance.

20. The system for powering a small kitchen appliance claim 19, wherein the controller is further configured to:
determine the power usage of the undercounter kitchen appliance; and
provide, based on the determination of the power usage of the undercounter kitchen appliance, reduced power capacity to the small kitchen appliance.

21. The system for powering a small kitchen appliance of claim 19, wherein the controller is further configured to:
determine the power usage of the small kitchen appliance; and
provide, based on the determination of the power usage of the small kitchen appliance, reduced power capacity to the undercounter kitchen appliance.

22. The system for powering a small kitchen appliance of claim 19 further comprising an indicator configured to be disposed on the upper surface of the countertop to indicate proper placement of the small kitchen appliance to receive power from the wireless power transmitter.

23. The system for powering a small kitchen appliance of claim 19 further comprising an indicator configured to be disposed on undercounter kitchen appliance to indicate proper placement of the small kitchen appliance to receive power from the wireless power transmitter.

24. The system for powering a small kitchen appliance of claim 19 further comprising a riser apparatus coupled to an enclosure of the undercounter kitchen appliance and configured to raise the wireless power transmitter closer to a lower surface of the countertop.

25. The system for powering a small kitchen appliance of claim 19, wherein the wireless power transmitter is an induction coil and the small kitchen appliance is a cooking apparatus, and wherein the induction coil is configured to generate heat in the cooking apparatus.

26. The system for powering a small kitchen appliance of claim 19 further comprising a fan configured to cool the wireless power transmitter.
